(19) United States
(12) Patent Application Publication
(10) Pub. No.: US 2002/0136814 A1
(43) Pub. Date: Sep. 26, 2002

(54) Shelf-stable soft flatbread

(75) Inventors: Keith Forneck, Hanover Park, IL (US); Kent R. Seger, Chicago, IL (US); Michael Miklus, Skokie, IL (US); Uraiwan Tangprasertchai, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: KRAFT FOODS HOLDINGS, INC.

(21) Appl. No.: 10/043,004

(22) Filed: Jan. 8, 2002

Related U.S. Application Data
(63) Continuation-in-part of application No. 09/598,633, filed on Jun. 21, 2000, now abandoned.

(51) Int. Cl. A21D 10/00

(52) U.S. Cl. 426/549

(57) ABSTRACT

A fully baked flatbread product is provided which can be stored under ambient conditions for extended periods of time and which retains its desirable soft texture for the shelf life of the product. Moreover, the fully baked, flatbread products of this invention retain their desirable soft texture throughout the entire shelf life of the products (e.g., about 6 months or even longer) if maintained under a modified atmosphere (i.e., low oxygen and preferably inert gas) at ambient conditions (i.e., about 60 to about 90° F.). The fully baked flatbread is prepared from dough comprising, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings.

### RELATED APPLICATION

The present application is a continuation-in-part of U.S. patent application Ser. No. 091598,633, filed on Jun. 21, 2000.

### FIELD OF THE INVENTION

This invention relates to a shelf-stable soft flatbread. More specifically, the present invention relates to a shelf-stable, fully cooked flatbread which can be stored under ambient conditions and which remains soft through its entire shelf life of 6 months or longer. The shelf-stable soft flatbread of this invention is especially adapted for use in cartons and/or packages which may also contain other ingredients for assembling a Mexican-type snack and/or complete meal.

### BACKGROUND OF THE INVENTION

Convenience foods (i.e., products which require a minimum amount of consumer preparation and are quick to prepare) are in high demand to accommodate today's busy lifestyles. Examples range from cheese and cracker snacks and canned stews to refrigerated bagels and some frozen dinners. Typically, such products will be eaten as packaged or after a brief heating period, preferably by microwave heating. Notably absent from this category are bread products.

Baked bread products are normally available as freshly prepared products that are intended to be consumed within a relatively short time period or as frozen products which can be stored in the frozen state for relatively long periods of time. Such frozen bread products, once thawed, generally must also be consumed within a relatively short time period. Baked bread products are generally not sold as refrigerated products. Once a fully baked bread product has been refrigerated, it tends to “toughen” or become leathery, stale, and/or dry. See, for example, David, English Bread and Yeast Cookery, American Edition, p. 255 (Viking Press, New York 1977). When such a bread product becomes “leathery” (a term of art), it becomes harder to chew and loses its palatability.

Feldmeir et al., U.S. Pat. No. 6,048,558, provided a meal kit containing a baked bread or dough product in a sealed pouch which is contained within a compartment contained within a base tray having an anti-fogging agent component. The anti-fogging agent assists in maintaining freshness and retarding staling under refrigerated, non-frozen conditions. Generally the anti-fogging agent is contained within a layer of the base tray or in other container elements so that enters the compartment in a time release manner so that it gradually blooms onto the internal surfaces within the meal kit. The anti-fogging agent is though to prevent the formation of water droplets within the container and thereby allow any trapped moisture to more easily evaporate from the meal kit.

Berkowitz et al., U.S. Pat. No. 5,059,432 (Oct. 22, 1001), extended the shelf life of a bakery product by including both a sucrose ester emulsifier and a polyvinyl-pyrrolidone synthetic hdrocolloid in a conventional dough mixture from which the bakery product is formed. The sucrose ester emulsifier had a IILB value of 15 to 16 and was present in the dough in an amount of up to 1 percent. The polyvinyl-pyrrolidone synthetic hdrocolloid was included in the dough at a level of 0.5 to 2.0 percent; generally the polyvinyl-pyrrolidone synthetic hdrocolloid had a molecular weight of 300,000 g/mole or higher. By employing these additives (i.e., sucrose ester emulsifier and polyvinyl-pyrrolidone synthetic hdrocolloid), Berkowitz et al. was able to control the water activity of the bread and increase the shelf life of the product.

There is a need for a flatbread product which can be baked, then stored for relatively long periods under ambient conditions, and subsequently eaten cold, warm, or hot (i.e., reheated) without further baking and without becoming leathery, and which retains the desired textural and taste properties. Moreover, there is a need for a fully baked flatbread product which can be used in a kit format and which retains its soft texture throughout the expected shelf life of the kit and remains tasty and chewable when eaten hot or cold. There further exists a need for a ready-to-eat flatbread product and kit containing a ready-to-eat flatbread product which can be stored for relatively long periods without the bread product becoming leathery, dry, and/or stale; and which remains equally tasty and satisfactorily chewable either hot or cold. It is generally preferred that the ready-to-eat flatbread product be provided as part of a kit containing other food products which can be consumed and enjoyed with the flatbread product.

The present invention provides such fully baked, ready-to-eat flatbread products and kits containing such flatbread products in combination with other complementary and associated food products. More particularly, the present invention provides fully baked, ready-to-eat flatbread products and kits containing such flatbread products in combination with other complementary and associated food products. The flatbread products of this invention can be eaten as is or after heating.

### SUMMARY OF THE INVENTION

The invention comprises a farinaceous flatbread which can be fully baked, stored at ambient temperatures for extended periods of time, and later served cold or reheated without becoming leathery, dry, stale and/or tough. Preferably, the flatbread is configured to have a circular shape. After baking, the flatbread preferably has a water activity in the range of about 0.80 to about 0.85 and, when stored under a modified atmosphere (i.e., low oxygen and preferably inert gas) at ambient conditions (i.e., about 60 to about 90° F.), retains satisfactory soft texture and chewability characteristics throughout a shelf life of at least 6 months without the use of additives such as anti-fogging agents and/or polyvinyl-pyrrolidone synthetic hdrocolloid and/or related additives (i.e., pyrrolidone-containing compounds).

### DETAILED DESCRIPTION OF PREFERRED EMBODIMENTS

The invention comprises a fully baked flatbread product which can be stored under ambient conditions for extended periods of time and which retains its desirable soft texture for the shelf life of the product. Moreover, the fully baked, flatbread products of this invention retain their desirable soft texture throughout the entire shelf life of the products (e.g., about 6 months or even longer) while maintained under a modified atmosphere (i.e., low oxygen and preferably inert gas) at ambient conditions (i.e., about 60 to about 90° F.) without the use of additives such as anti-fogging agents and/or polyvinyl-pyrrolidone synthetic hdrocolloid and/or related additives (i.e., pyrrolidone-containing compounds).

A preferred fully baked flatbread product of the present invention is preferably circular with a diameter of about 4 to about 8 inches and about 0.1 to about 0.5 inches thick. More preferably, the flatbread of this invention is about 5 to about 7 inches in diameter and about 0.1 to about 0.25 inches thick. Of course, as those skilled in the art will realize, other shapes and dimensions can be used if desired. Generally, the flatbread of this invention is the color of typical flour tortillas; the flatbread may be non-seasoned or seasoned.

The fully baked flatbread is preferably packaged in a pouch, envelope or the like, under inert gas and/or inert gas flushed conditions. Such separate packages can be formed from plastic film (e.g., pouches), paper, metal foil, or laminates containing two or more of these materials. The materials employed for the containers may include oxygen-impermeable materials, water barrier layers, and the like as desired.

The percentages used in the present specification to describe the flatbread dough are generally “baker's percentages,” which are weight percentages based on the weight of flour used in a specific recipe (generally per 100 pounds of flour). For example, for 100 pounds of flour in a recipe, 57 percent or pounds water and 1.5 percent or pounds salt would mean the addition of 57 pounds of water and 1.5 pounds of salt, respectively, to 100 pounds of flour. Of course, such baker's percentages do not normally add up to 100 percent. Conventional percentages can be calculated from baker's percentages by normalizing to 100 percent.

Baking science involves a complicated process employing time, temperature, and relative humidity to produce various food products. The time, temperature and relative humidity parameters are generally different for bread, rolls, pizza crusts, pastries, and cereal products, not only with regard to their appearance (color, size, and the like), but also with regard to the development and functioning of formula ingredients responsible for dough development, texture, and size. Some of the desirable changes caused by baking are protein denaturing, starch gelatinization, moisture migration, and veracity (cell development or grain). Although many factors may be involved in preparing a baked product which is appealing in the eyes of the ultimate consumer, a manufacturer must also consider items such as shelf life and how a consumer will actually use a product. Consequently, it is desirable to have some quantitative measure by which one can determine whether a production line product meets specification. One such measure is water activity. The flatbread products of the present invention will generally have water activities of about 0.80 to about 0.85 and preferably about 0.835. The water activity of the flatbread product may be measured within 24 hours after the fully baked flatbread product is removed from the baking oven, after the product is in the package. Moisture content of the packaged flatbread may be measured using an a_{W} meter or by weight difference between the product after cooling to about 100° F. and after further, more complete drying (i.e., using a desiccator or other suitable and reliable method). Preferably, the moisture content of the fully baked flatbread product is about 20 to about 30 percent, and preferably about 25 to about 27 percent. The pH of the flatbread is generally in the range of about 5.1 to about 5.5 with a pH of about 5.3 being preferred.

Since yeast is included in the formulation of the flatbread product, a fermentation or rising step is included in the dough preparation. The fermentation step allows the yeast to produce carbon dioxide gas which stretches and mellows the gluten contained in the flour and aids in producing good flavor and texture. The flatbread dough formulations of the present invention generally have significantly higher levels of corn syrup and glycerin than do conventional dough formulations. Although not wishing to be limited by theory, it is believed that the high levels of corn syrup and glycerin, along with dehydration during baking, allows lower water activities to be obtained while still maintaining soft texture. These factors appear to contribute to the long shelf live (i.e., about 6 months or longer) if properly packaged. Moreover, the desirable soft texture is maintained throughout the long shelf life.

A basic recipe (in baker's percentages) for the flatbread product prepared according to the preferred embodiment of the invention will generally be as follows:

| | | Preferred | |
|---|---|---|---|
| | Range | Range | Most Preferred |
| Ingredient | (% flour basis) | (% flour basis) | (% flour basis) |
| Flour | 100 | 100 | 100 |
| Water | 25-40 | 35-40 | 39 |
| Vegetable Oil | 5-20 | 13-15 | 15 |
| Glycerin | 5-20 | 10-12 | 11 |
| Corn Syrup Solids | 5-20 | 10-12 | 11.7 |
| Baking Powder | 1-3 | 1-2 | 2 |
| Dried Yeast | 1-4 | 2-3 | 2 |
| Salt | 1-4 | 1-2 | 2 |
| Potassium Sorbate | 0-1 | 0.25-0.5 | 0.4 |
| Calcium | 0-1 | 0.25-0.5 | 0.29 |
| Propionate | | | |
| Monoglyceride & | 0-2 | 1-2 | 1 |
| Diglycerides | | | |
| Fumeric Acid | 0-2 | 0.1-0.5 | 0.38 |
| L-Cysteine | 0-1 | 0-0.1 | 0.02 |
| Hydrochloride | | | |
| Spices | 0-10 | 0-5 | 0 |

The flour is preferably hard wheat bread flour made from hard spring or winter wheat. The vegetable oil is preferably partially hydrogenated; for example, a partially hydrogenated cottonseed, corn, soybean, sunflower, canola, and similar partially hydrogenated vegetable oils as well as mixtures thereof. The preferred vegetable oils are corn, canola, sunflower seed, cottonseed and soybean oils, or mixture thereof. Compressed yeast may be substituted for the dried yeast used in the above basic recipe. If compressed yeast is used, the baker's percentage or weight is approximately doubled to account for the water content of the compressed yeast; likewise, the amount of water added may be reduced to account for the water content of the compressed yeast. Therefore, if compressed yeast is used in the above general recipe in place of dried yeast, the amount of compressed yeast will be in the range of about 2 to about 8 baker's percent, preferably about 4 to about 6 baker's percent. The present dough formulations do not require, and should not contain, either the anti-fogging agents of U.S. Pat. No. 6,048,558 or the pyrrolidone-containing additives of U.S. Pat. No. 5,059,432.

The dough is preferably prepared by mixing the dough ingredients using conventional equipment and procedures. After mixing, the dough is allowed to relax at ambient conditions for about 10 minutes. After relaxing, the dough is divided into dough “balls” (generally about 60 to 65 g to obtain fully baked flatbread products having a preferred diameter of about 6 inches and preferred thickness of about 0.1 to about 0.25). The dough balls are preferably proofed for about 10 minutes at about 85 percent relative humidity and a temperature of about 95 to about 105° F. The dough balls are then pressed, preferably using heated press at a temperature of about 300 to about 450° F., and more preferably at about 350 to about 400° F., to obtained the desired flatbread dimensions. Preferably the pressure of the heated press is about 200 to about 500 psi, more preferably about 250 to about 275 psi, with a dwell time in the press of about 0.5 to about 5 seconds, more preferably about 1 to about 2 seconds. After pressing, the flatbread product are then baked at a temperature of about 350 to about 500° F. for about 50 to 120 seconds. After cooling, the flatbread product can be packaged, preferably under an inert gas or inert-gas flushed atmosphere.

The present invention provides a farinaceous flatbread product which can be baked and then later served cold or reheated without becoming leathery, dry, stale and/or tough. Generally, the flatbread product will have a water activity in the range about 0.80 to about 0.85 and will retain satisfactory texture and chewability characteristics throughout its shelf life. The flatbread product of this invention is especially adapted for use in a “single-serving” kit as a snack or in a “multiple-serving” kit for a meal. Such kits will contain one or more flatbread products along with other appropriate food products or components. Especially preferred are kits containing several individual flatbread products, a seasoning mix such that a filling can be prepared using consumer-supplied chicken or meat, and a sauce (e.g., tomato and onion salsa, tomato salsa, and the like) for topping the filled flatbread. The flatbreads of the present invention are especially adapted for inclusion in kits for Mexican type snacks and/or meals. Additional components for such kits could include, for example, pizza sauce, tomato sauce, cheese, cheese products, shredded cheese, cheese sauces, traditional Mexican condiments and sauces, tortilla chips with or without dip, salad ingredients, salad dressings, proteinaceous products such as pepperoni or other meat products, and the like. Of course, other additional products, including both food and non-food items, can be included in the kit. Preferably, such a single-serving kit is in the form of a tray having separate compartments and/or pouches for the various ingredients formed therein. The pouches preferably are sealed under an inert atmosphere to increase the shelf life of the product or kit. The various compartments within the tray may also be sealed under an inert atmosphere. The other components can also be sealed in similar pouches, cups, or compartment form in the tray itself which can then be sealed. For multiple-serving kits, the individual components can be separately sealed under inert atmosphere conditions and then included in a box or other packaging material. Preferably, such multiple-serving kits contain a plurality of flatbread products, a seasoning mix suitable to be used by a consumer with chicken or meat supplied by the consumer to provide a filling that can be applied to the flatbread, and a sauce to be applied to the filling and/or flatbread. The plastic films used for the pouches and/or the tray seal preferably comprise oxygen barrier layers. The various components used to make the trays, pouches, and other containers in the kits of this invention do not require, and should not contain, the anti-fogging agents of U.S. Pat. No. 6,048,558.

The following example is intended to illustrate the invention and not to limit or otherwise restrict the invention.

### EXAMPLE

A flatbread dough was made using the following formulation:

| | Amounts |
|---|---|
| Ingredient | (% flour basis) |
| Flour | 100 |
| Water | 39.0 |
| Partially Hydrogenated Vegetable Oil | 15.0 |
| Glycerin | 11.0 |
| Corn Syrup Solids | 11.7 |
| (Maltrin M250; 23.0 to 27.0 DE Equivalent) | |
| Baking Powder | 2.0 |
| Dried Yeast | 2.0 |
| Salt | 2.0 |
| Potassium Sorbate | 0.4 |
| Calcium Propionate | 0.29 |
| Monoglyceride & Diglycerides | 1.0 |
| Fumeric Acid | 0.38 |
| L-Cysteine Hydrochloride | 0.02 |

All dry components were mixed using low speed mixing for about 6 minutes, followed by the wet components using medium speed mixing for about 8 minutes. The resulting dough was allowed to relax for about 10 minutes and then separated into dough balls (about 60 to about 65 g).

The dough balls were proofed at about 85 percent relative humidity and about 95 to about 105° F. Proofing was carried out for about 10 minutes; satisfactory proofing can be determined when the dough stays indented when pressed lightly with a finger. After proofing, the proofed dough balls were formed into the desired shape using a heated press (top plate at about 325° F. and bottom plate at about 350° F.). The shaped flatbread was baked at about 400° F. in a commercial oven for about 1 to about 1.25 minutes to yield the fully balked flatbread product.

Preferably, the fully baked flatbread products, after cooling, are packaged in a film pouch or bag using vacuum and then flushing with nitrogen before sealing. No anti-fogging agents or pyrrolidone-containing additives are used in either the dough formulations or in or within the packing materials. Under ambient conditions, the flatbread products of this invention have a shelf life of at least 6 months and maintain their soft texture throughout this shelf life period. Of course, other methods of providing a low-oxygen atmosphere can be used.

We claim:

1. A fully baked flatbread product comprising a fully baked flatbread made with a formulation including corn syrup and glycerine of a desired shape and having a water activity of about 0.80 to about 0.85 which gives the flatbread product a soft texture, wherein the soft texture can be maintained, when sealed in an inert atmosphere and stored at ambient temperatures, for periods of at least 6 months without the use of anti-fogging agents or pyrrolidone-containing additives.

2. The fully baked flatbread product as defined in claim 1, wherein the desired shape is circular with a diameter of about 4 to about 8 inches and a thickness of about 0.1 to about 0.5 inches.

3. The fully baked flatbread product as defined in claim 1, wherein the fully baked flatbread is prepared from dough comprising, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings.

4. The fully baked flatbread product as defined in claim 2, wherein the fully baked flatbread is prepared from dough comprising, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings.

5. The fully baked flatbread product as defined in claim 3, wherein the fully baked flatbread is prepared from dough comprising, in baker's percentages, about 100 pounds flour, about 35 to about 40 pounds water, about 13 to about 15 pounds partially hydrogenated vegetable oil, about 10 to about 12 pounds glycerin, about 10 to about 12 pounds corn syrup solids, about 1 to about 2 pounds baking powder, about 2 to about 3 pounds dried yeast, about 1 to about 2 pounds salt, about 0.25 to about 0.5 pounds potassium sorbate, about 0.25 to about 0.5 pounds calcium propionate, about 1 to about 2 pounds monoglycerides and diglycerides, about 0.1 to about 0.5 pounds fumeric acid, 0 to about 0.1 pounds cysteine hydrochloride, and 0 to about 5 pounds spices and seasonings.

6. The fully baked flatbread product as defined in claim 4, wherein the fully baked flatbread is prepared from dough comprising, in baker's percentages, about 100 pounds flour, about 35 to about 40 pounds water, about 13 to about 15 pounds partially hydrogenated vegetable oil, about 10 to about 12 pounds glycerin, about 10 to about 12 pounds corn syrup solids, about 1 to about 2 pounds baking powder, about 2 to about 3 pounds dried yeast, about 1 to about 2 pounds salt, about 0.25 to about 0.5 pounds potassium sorbate, about 0.25 to about 0.5 pounds calcium propionate, about 1 to about 2 pounds monoglycerides and diglycerides, about 0.1 to about 0.5 pounds fumeric acid, 0 to about 0.1 pounds cysteine hydrochloride, and 0 to about 5 pounds spices and seasonings.

7. The fully baked flatbread product as defined in claim 5, wherein the fully baked flatbread is prepared from dough comprising, in baker's percentages, about 100 pounds flour, about 39 pounds water, about 15 pounds partially hydrogenated vegetable oil, about 11 pounds glycerin, about 11.7 pounds corn syrup solids, about 2 pounds baking powder, about 2 pounds dried yeast, about 2 pounds salt, about 0.4 pounds potassium sorbate, about 0.29 pounds calcium propionate, about 1 pounds monoglycerides and diglycerides, about 0.38 pounds fumeric acid, and about 0.02 pounds cysteine hydrochloride.

8. The fully baked flatbread product as defined in claim 6, wherein the fully baked flatbread is prepared from dough comprising, in baker's percentages, about 100 pounds flour, about 39 pounds water, about 15 pounds partially hydrogenated vegetable oil, about 11 pounds glycerin, about 11.7 pounds corn syrup solids, about 2 pounds baking powder, about 2 pounds dried yeast, about 2 pounds salt, about 0.4 pounds potassium sorbate, about 0.29 pounds calcium propionate, about 1 pounds monoglycerides and diglycerides, about 0.38 pounds fumeric acid, and about 0.02 pounds cysteine hydrochloride.

9. The fully baked flatbread product as defined in claim 3, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

10. The fully baked flatbread product as defined in claim 4, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

11. The fully baked flatbread product as defined in claim 5, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

12. The fully baked flatbread product as defined in claim 6, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

13. The fully baked flatbread product as defined in claim 7, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

14. The fully baked flatbread product as defined in claim 8, wherein the fully baked flatbread is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

15. A shelf stable kit for making a Mexican style snack or meal, said kit comprising a carton, at least one fully baked flatbread product; and one or more other food components; a plurality of containers within the carton to hermetically seal the flatbread product and the one or more other food components from atmosphere external of the carton; wherein the flatbread product is made with a formulation including corn syrup and glycerine and has a water activity in the range of about 0.80 to about 0.85 which gives the flatbread product a soft texture, wherein the soft texture can be maintained, when sealed in an inert atmosphere and stored at ambient temperatures, for periods of at least 6 months without the use of anti-fogging agents or pyrrolidone-containing additives.

16. The shelf stable kit as defined in claim 15, wherein the flatbread product and each of the other food components are hermetically sealed in individual packages under an inert atmosphere or under inert gas flushed conditions.

17. The shelf stable kit as defined in claim 15, wherein the other food component is selected from the groups consisting of pizza sauce, tomato sauce, cheese, cheese products, shredded cheese, cheese sauces, tortilla chips with or without dip, salad ingredients, salad dressings, and proteinaceous products wherein the other food components are hermetically sealed from each other under an inert atmosphere or under inert gas flushed conditions.

18. The shelf stable kit as defined in claim 15, wherein the kit is a multiple-serving meal kit containing a plurality of flatbread products, a seasoning mix suitable to be used by a consumer with chicken or meat supplied by the consumer to provide a filling that can be applied to the flatbread, and a sauce to be applied to the filling or flatbread.

19. The shelf stable kit as defined in claim 15, wherein the flatbread product is circular with a diameter of about 4 to about 8 inches and a thickness of about 0.1 to about 0.5 inches; and wherein the flatbread product is prepared from dough comprising, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings.

20. The shelf stable kit as defined in claim 19, wherein the flatbread product is prepared from dough comprising, in baker's percentages, about 100 pounds flour, about 35 to about 40 pounds water, about 13 to about 15 pounds partially hydrogenated vegetable oil, about 10 to about 12 pounds glycerin, about 10 to about 12 pounds corn syrup solids, about 1 to about 2 pounds baking powder, about 2 to about 3 pounds dried yeast, about 1 to about 2 pounds salt, about 0.25 to about 0.5 pounds potassium sorbate, about 0.25 to about 0.5 pounds calcium propionate, about 1 to about 2 pounds monoglycerides and diglycerides, about 0.1 to about 0.5 pounds fumeric acid, 0 to about 0.1 pounds cysteine hydrochloride, and 0 to about 5 pounds spices and seasonings.

21. The shelf stable kit as defined in claim 19, wherein the flatbread product is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

22. The shelf stable kit as defined in claim 20, wherein the flatbread product is prepared by a process comprising:
(1) forming the dough;
(2) relaxing the dough for about 5 to about 10 minutes at ambient temperature;
(3) dividing the relaxed dough into individual dough balls;
(4) proofing the dough balls at a relative humidity of about 70 to about 85 relative humidity at a temperature of about 95 to 105° F. for about 5 to about 30 minutes;
(5) forming the proofed dough balls into the desired shape for the flatbread;
(6) baking the desired shaped flatbread at a temperature of about 300 to about 450° F. until fully baked;
(7) cooling the fully baked flatbread; and
(8) sealing the cooled fully baked flatbread in the inert atmosphere.

23. A fully baked flatbread product comprising a fully baked flatbread of a desired shape and having a water activity of about 0.80 to about 0.85 and a soft texture; wherein the fully baked flatbread is prepared from dough consisting essentially of, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings; and wherein the soft texture can be maintained, when sealed in an inert atmosphere and stored at ambient temperatures, for periods of at least 6 months.

24. The fully baked flatbread product of claim 23, wherein the flatbread product is prepared from dough consisting essentially of, in baker's percentages, about 100 pounds flour, about 35 to about 40 pounds water, about 13 to about 15 pounds partially hydrogenated vegetable oil, about 10 to about 12 pounds glycerin, about 10 to about 12 pounds corn syrup solids, about 1 to about 2 pounds baking powder, about 2 to about 3 pounds dried yeast, about 1 to about 2 pounds salt, about 0.25 to about 0.5 pounds potassium sorbate, about 0.25 to about 0.5 pounds calcium propionate, about 1 to about 2 pounds monoglycerides and diglycerides, about 0.1 to about 0.5 pounds fumeric acid, 0 to about 0.1 pounds cysteine hydrochloride, and 0 to about 5 pounds spices and seasonings.

25. A shelf stable kit for making a Mexican style snack or meal, said kit comprising a carton, at least one fully baked flatbread product having a water activity of about 0.80 to about 0.85 and a soft texture; and one or more other food components; a plurality of containers within the carton to hermetically seal the flatbread product and the one or more other food components from atmosphere external of the carton; wherein the fully baked flatbread is prepared from dough consisting essentially of, in baker's percentages, about 100 pounds flour, about 25 to about 40 pounds water, about 5 to about 20 pounds partially hydrogenated vegetable oil, about 5 to about 20 pounds glycerin, about 5 to about 20 pounds corn syrup solids, about 1 to about 3 pounds baking powder, about 1 to about 4 pounds dried yeast, about 1 to about 4 pounds salt, 0 to about 1 pounds potassium sorbate, 0 to about 1 pounds calcium propionate, 0 to about 2 pounds monoglycerides and diglycerides, 0 to about 2 pounds fumeric acid, 0 to about 1 pounds cysteine hydrochloride, and 0 to about 10 pounds spices and seasonings; and wherein the soft texture can be maintained, when sealed in an inert atmosphere and stored at ambient temperatures, for periods of at least 6 months.

26. The shelf stable kit for making a Mexican style snack or meal of claim 25, wherein the flatbread product is prepared from dough consisting essentially of, in baker's percentages, about 100 pounds flour, about 35 to about 40 pounds water, about 13 to about 15 pounds partially hydrogenated vegetable oil, about 10 to about 12 pounds glycerin, about 10 to about 12 pounds corn syrup solids, about 1 to about 2 pounds baking powder, about 2 to about 3 pounds dried yeast, about 1 to about 2 pounds salt, about 0.25 to about 0.5 pounds potassium sorbate, about 0.25 to about 0.5 pounds calcium propionate, about 1 to about 2 pounds monoglycerides and diglycerides, about 0.1 to about 0.5 pounds fumeric acid, 0 to about 0.1 pounds cysteine hydrochloride, and 0 to about 5 pounds spices and seasonings.
